(19) United States
(12) Patent Application Publication
(10) Pub. No.: US 2012/0016092 A1
(43) Pub. Date: Jan. 19, 2012

(54) Catalysts based on quinoline precursors

(76) Inventors: Sandor Nagy, Naperville, IL (US); Linda N. Winslow, Cincinnati, OH (US); Shahram Mihan, Bad Soden (DE); Lenka Lukesova, Frankfurt (DE); Ilya E. Nifant'ev, Moscow (RU); Pavel V. Ivchenko, Moscow (RU); Vladimir V. Bagrov, Moscow (RU)

(21) Appl. No.: 12/804,122

(22) Filed: Jul. 14, 2010

(51) Int. Cl. C08F 4/76; B01J 31/12; B01J 31/02

(52) U.S. Cl. 526/170; 502/167; 502/155

(57) ABSTRACT

Catalysts useful for polymerizing olefins are disclosed. The catalysts comprise a transition metal complex, an optional activator, and an optional support. The complex is the reaction product of a Group 3-6 transition metal source, an optional alkylating agent, and a ligand precursor comprising a 2-imino-8-anilinoquinoline or a 2-aminoalkyl-8-anilinoquinoline. The catalysts, which are easy to synthesize by in-situ metallation of the ligand precursor, offer polyolefin manufacturers good activity and the ability to make high-molecular-weight ethylene copolymers that have little or no long-chain branching.

### FIELD OF THE INVENTION

The invention relates to non-metallocene catalysts useful for polymerizing olefins. The catalysts are made using a quinoline-based ligand precursor.

### BACKGROUND OF THE INVENTION

While Ziegler-Natta catalysts are a mainstay for polyolefin manufacture, single-site (metallocene and non-metallocene) catalysts represent the industry's future. These catalysts are often more reactive than Ziegler-Natta catalysts, and they produce polymers with improved physical properties. The improved properties include controlled molecular weight distribution, reduced low molecular weight extractables, enhanced incorporation of α-olefin comonomers, lower polymer density, controlled content and distribution of long-chain branching, and modified melt rheology and relaxation characteristics.

Traditional metallocenes incorporate one or more cyclopentadienyl (Cp) or Cp-like anionic ligands such as indenyl, fluorenyl, or the like, that donate pi-electrons to the transition metal. Non-metallocene single-site catalysts, including ones that capitalize on the chelate effect, have evolved more recently. Examples are the bidentate 8-quinolinoxy or 2-pyridinoxy complexes of Nagy et al. (see U.S. Pat. No. 5,637,660), the late transition metal bisimines of Brookhart et al. (see Chem. Rev. 100 (2000) 1169), and the diethylenetriamine-based tridentate complexes of McConville et al. or Shrock et al. (e.g., U.S. Pat. Nos. 5,889,128 and 6,271,323).

In numerous recent examples, the bi- or tridentate complex incorporates a pyridyl ligand that bears a heteroatom β- or γ- to the 2-position of the pyridine ring. This heteroatom, typically nitrogen or oxygen, and the pyridyl nitrogen chelate the metal to form a five- or six-membered ring. For some examples, see U.S. Pat. Nos. 7,439,205; 7,423,101; 7,157,400; 6,653,417; and 6,103,657 and U.S. Pat. Appl. Publ. Nos. 2008/0177020 and 2010/0022726. In some of these complexes, an aryl substituent at the 6-position of the pyridine ring is also available to interact with the metal through C—H activation to form a tridentate complex (see, e.g., U.S. Pat. Nos. 7,115,689; 6,953,764; 6,706,829).

Less frequently, quinoline-based bi- or tridentate complexes have been described. The tridentate complexes typically lack an 8-anilino substituent, a 2-imino or 2-aminoalkyl substituent, or both. For example, U.S. Pat. Nos. 7,253,133 (col. 69, complex A-6) and 7,049,378 (col. 18, Example 2) disclose multidentate complexes that can incorporate a quinoline moiety, but the quinoline is not substituted at the 2-position and is not substituted at the 8-position with an anilino group. U.S. Pat. No. 6,939,969 describes bi- and tridentate quinoline-containing ligands, and at least one early transition metal complex (col. 20, Example 6) is disclosed. Complexes having an 8-anilino substituent are described, but none of the quinoline ligands are substituted with 2-imino or 2-aminoalkyl groups. U.S. Pat. No. 6,103,657 teaches bidentate complexes from quinoline ligands having a 2-imino group (Table 2, Example 5c). The complexes also lack an 8-anilino substituent.

Recently (see copending application Ser. No. 12/460,621, filed Jul. 22, 2009, docket #88-2205A), we described olefin polymerization catalysts based on dianionic, tridentate 2-aryl-8-anilinoquinoline ligands that coordinate to the metal through a pair of nitrogens and a carbon from the 2-aryl substituent. Thus, these complexes involve “CNN” rather than “NNN” coordination. In copending application Ser. No. 12/460,628, also filed Jul. 22, 2009 (docket #88-2206A), we disclosed catalysts that incorporate a dianionic, tridentate 2-(2-aryloxy)quinoline or 2-(2-aryloxy)dihydroquinoline ligand. These involve “ONN” coordination using an oxygen from the 2-aryloxy substituent.

New non-metallocene catalysts useful for making polyolefins continue to be of interest. In particular, tridentate complexes that can be readily synthesized from inexpensive reagents are needed. The complexes should not be useful only in homogeneous environments; a practical complex can be used as an unsupported solid or can be supported on an inorganic support such as silica and readily activated toward olefin polymerization with alumoxanes and/or boron-containing cocatalysts. Ideally, the catalysts have good activities and the ability to make ethylene copolymers having high molecular weights and limited long-chain branching.

### SUMMARY OF THE INVENTION

The invention relates to catalysts useful for polymerizing olefins. The catalysts comprise a transition metal complex, an optional activator, and an optional support. The complex is the reaction product of a Group 3-6 transition metal source, an optional alkylating agent, and a ligand precursor comprising a 2-imino-8-anilinoquinoline or a 2-aminoalkyl-8-anilinoquinoline. The ligand precursor, which becomes a mono- or dianionic ligand upon reaction with the transition metal source, has three nitrogens available to coordinate to the metal in the resulting complex. The catalysts are easy to synthesize by in-situ metallation of the ligand precursor, and they offer polyolefin manufacturers good activity and the ability to make high-molecular-weight ethylene copolymers that have little or no long-chain branching.

### DETAILED DESCRIPTION OF THE INVENTION

Olefin polymerization catalysts of the invention comprise a complex that is the reaction product of a Group 3-6 transition metal source, a ligand precursor, and optionally an alkylating agent.

The transition metal source comprises a Group 3-6 metal. Suitable metals include scandium, yttrium, zirconium, titanium, hafnium, vanadium, niobium, chromium, molybdenum, tungsten, and the like. More preferred metals are in Groups 4-6, particularly zirconium, titanium, hafnium, vanadium, and tungsten. Group 4 metals are particularly preferred. The source can be any Group 4-6 complex or salt that will combine with the ligand precursor to give a tridentate complex comprising the precursor. Thus, suitable transition metal sources include halides, oxides, amides, alkoxides, alkyls, aryls, aralkyls, alkaryls, and the like. Specific examples include zirconium tetrachloride, vanadium oxytrichloride, titanium tetrabenzyl, hafnium tetrabenzyl, and the like. Preferred transition metal sources have the formula MX₄ wherein M a Group 4 metal and each X is independently alkyl, aryl, aralkyl, alkaryl, alkoxy, halide, heterocyclyl, or dialkylamido.

The transition metal source reacts with a ligand precursor. Suitable ligand precursors comprise a 2-imino-8-anilinoquinoline or a 2-aminoalkyl-8-anilinoquinoline. The “NNN” precursor can coordinate to the transition metal as a tridentate ligand, mono- or dianionically, using three nitrogens. At least one nitrogen is neutral, that being the tertiary amine group of the quinoline moiety. The 8-anilinoquinoline portion of the precursor has quinoline and aniline functionalities that can be further substituted. For example, the anilino ring can be substituted with halides, alkyls, and the like, or fused to other carbocyclic or heterocyclic rings. Similarly, the 2-imino and 2-aminoalkyl functionalities can be further substituted or part of a heterocyclic ring structure as in a benzothiazolyl group.

The transition metal source and ligand precursor are often combined in roughly equimolar amounts. Thus, the preferred molar ratios of transition metal to ligand precursor are from 0.5 to 2, more preferably from 0.8 to 1.5, and most preferably from 0.9 to 1.1

The ligand precursor preferably has the general structure:

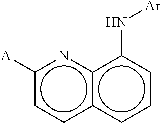

in which Ar is an aryl group, A is a 2-imino or 2-aminoalkyl substituent, and any of the ring carbons is optionally substituted with an alkyl, aryl, aralkyl, alkaryl, halide, haloalkyl, heterocyclyl, trialkylsilyl, alkoxy, amino, thio, or phosphino group, or any pair of adjacent ring carbons join to form a 5 to 7-membered carbocyclic or heterocyclic ring. Preferably, A is a monovalent substituent having the structure:

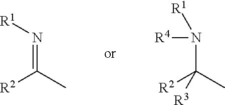

in which each of R¹-R⁴ is independently hydrogen, alkyl, aryl, aralkyl, alkaryl, halide, heterocyclyl, trialkylsilyl, alkoxy, amino, thio, or phosphino, or any of R¹-R⁴ join to form a 5 to 7-membered carbocyclic or heterocyclic ring.

Thus, in one aspect of the invention, the ligand precursor has the general structure:

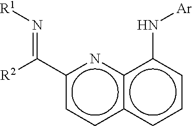

where Ar, R¹, and R² are defined as described above, and in another aspect, the precursor has the general structure:

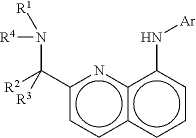

where Ar and R¹-R⁴ are defined as described above.

The ligand precursor can be synthesized by any convenient method. In one valuable approach, a 2,8-dihaloquinoline is used as a starting material as illustrated below in the preparation of Precursor 1. Palladium-promoted substitution of a lithium enolate for the 2-bromo group provides, upon workup, an acetyl group at the 2-position. This is readily converted to the corresponding 2-imino compound by reaction with an amine, usually an aniline compound, to form the Schiff base compound. Palladium-catalyzed coupling can then be used to replace the halogen at the 8-position of the quinoline ring with an anilino group.

In another approach, illustrated by the preparation of Precursor 2, the 2,8-dihaloquinoline is initially coupled to a benzothiazole or benzoxazole in the presence of a copper catalyst to replace the 2-halo substituent, and the 8-position is modified as described above.

Precursors having a 2-aminoalkyl substituent are conveniently made from the corresponding 2-imino compounds by addition of alkali metal or alkaline earth metal hydrides, alkyls, or other strong nucleophiles (e.g., phenyllithium or n-butyllithium) to the —C═N bond of the imine followed by an aqueous quench. This approach is shown in the synthesis of Precursor 4, below.

A few exemplary ligand precursors:

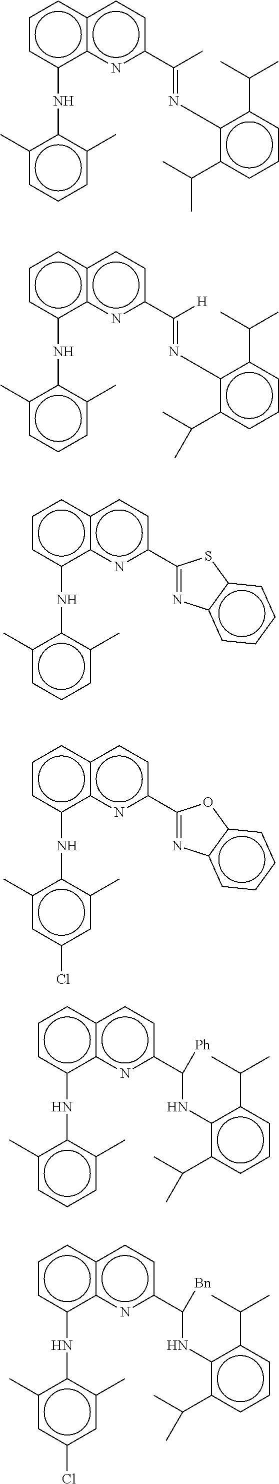

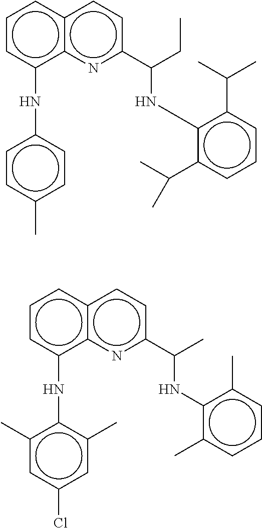

The ligand precursors react with a Group 3-6 transition metal source and an optional alkylating agent to produce complexes used in the inventive catalysts.

Suitable alkylating agents are well known in the art. They include, for example aluminum, boron, and magnesium alkyls. Specific examples include triethylaluminum, trimethylaluminum, triisobutylaluminum, di-n-butylmagnesium, triethylborane, and the like, and mixtures thereof. When an alkylating agent is used, it is typically present in an amount within the range of 0.1 to 10, preferably from 0.5 to 5, and more preferably from 1 to 2 moles of alkylating agent per mole of transition metal.

For some complexes, the ligand precursor has the structure:

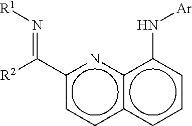

and the resulting complex has the structure:

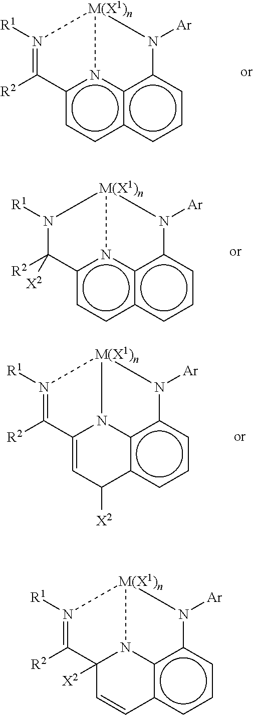

wherein M is a Group 3-6 metal, each X¹ is independently alkyl, aryl, aralkyl, alkaryl, halide, heterocyclyl, or dialkylamido, X² is hydrogen, alkyl, aryl, aralkyl, or alkaryl, and n is an integer from 1 to 5 that satisfies the valence of M. Preferably, M is a Group 4 metal.

Particularly preferred complexes of this type have the general structure:

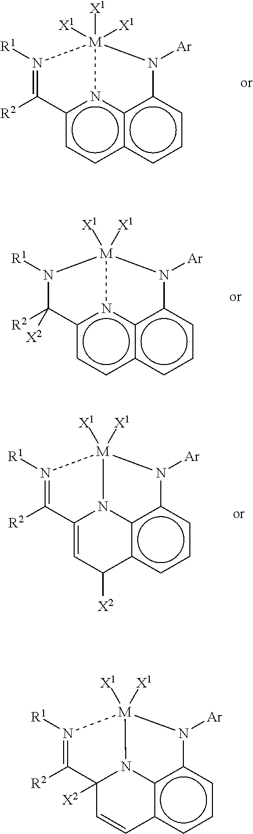

in which M is a Group 4 metal and the other variables are as defined above.

In another aspect of the invention, the ligand precursor has the structure:

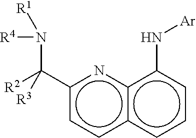

and the complex has the structure:

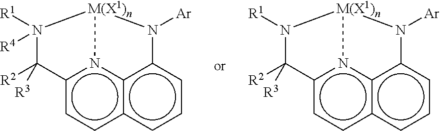

wherein M is a Group 3-6 metal, each X¹ is independently alkyl, aryl, aralkyl, alkaryl, halide, heterocyclyl, or dialkylamido, and n is an integer from 1 to 5 that satisfies the valence of M. Again, M is preferably a Group 4 metal.

Particularly preferred complexes of this type have the general structure:

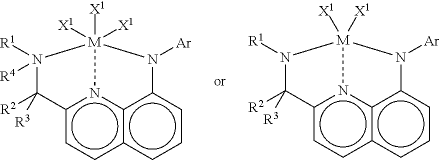

in which M is a Group 4 metal and the other variables are as defined above.

A few exemplary complexes:

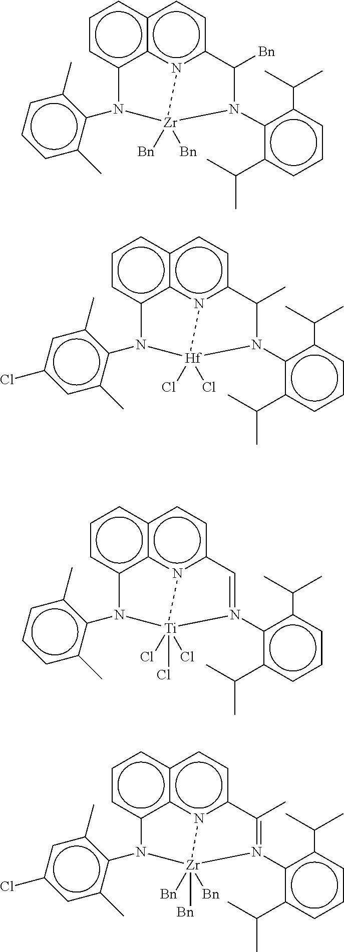

The complexes can be synthesized and isolated prior to use. In a preferred approach, the complex is not isolated. Rather, it is generated by “in-situ metallation.” In this process, the transition metal source, ligand precursor, and optional alkylating agent are combined, usually in an inert solvent under ambient conditions. The activator (if any) is then added, and mixing continues. Next, the complex/activator mixture is applied to the optional support, either as a slurry or by incipient wetness. The resulting catalyst is suitable for use in an olefin polymerization without ever isolating a complex. The in-situ metallation strategy avoids the costs of additional processing and purification.

The catalysts preferably include one or more activators. The activator helps to ionize the complex and further activate the catalyst. Suitable activators are well known in the art. Examples include alumoxanes (methyl alumoxane (MAO), PMAO, ethyl alumoxane, diisobutyl alumoxane), alkylaluminum compounds (triethylaluminum, diethylaluminum chloride, trimethylaluminum, triisobutylaluminum), and the like. Suitable activators include boron and aluminum compounds having Lewis acidity such as ionic borates or aluminates, organoboranes, organoboronic acids, organoborinic acids, and the like. Specific examples include lithium tetrakis(pentafluorophenyl)borate, lithium tetrakis(pentafluorophenyl)aluminate, anilinium tetrakis(pentafluorophenyl)-borate, trityl tetrakis(pentafluorophenyl)borate (“F20”), tris(pentafluorophenyl)-borane (“F15”), triphenylborane, tri-n-octylborane, bis(pentafluorophenyl)borinic acid, pentafluorophenylboronic acid, and the like. These and other suitable boron-containing activators are described in U.S. Pat. Nos. 5,153,157, 5,198,401, and 5,241,025, the teachings of which are incorporated herein by reference. Suitable activators also include aluminoboronates—reaction products of alkyl aluminum compounds and organoboronic acids—as described in U.S. Pat. Nos. 5,414,180 and 5,648,440, the teachings of which are incorporated herein by reference. Particularly preferred activators are alumoxanes, boron compounds having Lewis acidity, and mixtures thereof.

The catalysts are preferably supported on an inorganic oxide such as silica, alumina, silica-alumina, magnesia, titania, zirconia, clays, zeolites, or the like. Silica is preferred. When silica is used, it preferably has a surface area in the range of 10 to 1000 m²/g, more preferably from 50 to 800 m²/g and most preferably from 200 to 700 m²/g. Preferably, the pore volume of the silica is in the range of 0.05 to 4.0 mL/g, more preferably from 0.08 to 3.5 mL/g, and most preferably from 0.1 to 3.0 mL/g. Preferably, the average particle size of the silica is in the range of 1 to 500 microns, more preferably from 2 to 200 microns, and most preferably from 2 to 45 microns. The average pore diameter is typically in the range of 5 to 1000 angstroms, preferably 10 to 500 angstroms, and most preferably 20 to 350 angstroms.

The support is preferably treated thermally, chemically, or both prior to use by methods well known in the art to reduce the concentration of surface hydroxyl groups. Thermal treatment consists of heating (or “calcining”) the support in a dry atmosphere at elevated temperature, preferably greater than 100° C., and more preferably from 150 to 800° C., prior to use. A variety of different chemical treatments can be used, including reaction with organo-aluminum, -magnesium, -silicon, or -boron compounds. See, for example, the techniques described in U.S. Pat. No. 6,211,311, the teachings of which are incorporated herein by reference.

Suitable catalysts also include unsupported solid catalysts prepared by emulsification as taught in WO 2010/052237, WO 2010/052260, WO 2010/052264, and related references. This generally involves forming an emulsion of the ligand precursor, the transition metal source, and any optional components (e.g., activator, alkylating agent) by combining the components with a fluorinated solvent (e.g., perfluoro-1,3-dimethylcyclohexane) and a fluorinated surfactant (e.g., perfluorooctyl-1,2-propenoxide). The emulsion is usually combined with additional fluorinated solvent to precipitate a solid, unsupported catalyst that is easily recovered from the fluorinated solvent.

The invention includes processes for polymerizing olefins. In one process, at least one of ethylene, propylene, and an α-olefin is polymerized in the presence of a catalyst of the invention. Preferred α-olefins are C₄-C₂₀ α-olefins such as 1-butene, 1-hexene, 1-octene, and the like. Ethylene and mixtures of ethylene with propylene or a C₄-C₁₀ α-olefin are particularly preferred. Most preferred are polymerizations of ethylene with 1-butene, 1-hexene, 1-octene, and mixtures thereof.

Many types of olefin polymerization processes can be used. Preferably, the process is practiced in the liquid phase, which can include slurry, solution, suspension, or bulk processes, or a combination of these. High-pressure fluid phase or gas phase techniques can also be used. In a preferred olefin polymerization process, a supported catalyst of the invention is used. The polymerizations can be performed over a wide temperature range, such as −30° C. to 280° C. A more preferred range is from 30° C. to 180° C.; most preferred is the range from 60° C. to 100° C. Olefin partial pressures normally range from 15 psig to 50,000 psig. More preferred is the range from 15 psig to 1000 psig.

The following examples merely illustrate the invention. Those skilled in the art will recognize many variations that are within the spirit of the invention and scope of the claims.

All intermediate compounds and complexes synthesized give satisfactory ¹H NMR spectra consistent with the structures indicated.

### Preparation of Ligand Precursor 1

### 2-Acetyl-8-bromoquinoline

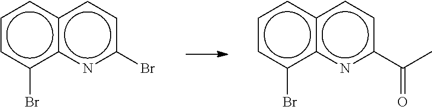

n-Butyllithium (32 mL of 2.5 M solution in hexanes, 80 mmol) is slowly added at −70° C. to a solution of ethylvinyl ether (16 mL, 160 mmol) in dry THF (140 mL). The solution is allowed to reach ambient temperature and stirring continues for an additional hour. The resulting solution is cooled to −70° C. followed by addition of anhydrous ZnCl₂ (10.9 g, 80 mmol), and the reaction mixture is again allowed to reach ambient temperature. A solution of catalysts (0.4 g of Pd(dba)₂ and 0.4 g of PPh₃ in 5 mL of THF) is first added to the resulting reaction mixture. This is stirred for 5 min., followed by addition of 2,8-dibromoquinoline (11.5 g, 40 mmol, prepared as described in Tetrahedron Lett. 46 (2005) 8419). The mixture stirs overnight and is then refluxed for 4 h. The resulting reaction mixture is treated with HCl (100 mL of 1 N solution) and is refluxed for an additional 4 h. The organic phase is separated, and the aqueous phase is extracted twice with diethyl ether. The combined organic phases are dried over anhydrous MgSO₄ and concentrated. The residue is dissolved in benzene and eluted through a short silica column. Removal of solvent results in 4.5 g of product (45% yield). ¹H NMR (CDCl₃): 8.24 (d, 1H); 8.14 (d, 1H); 8.09 (d, 1H); 7.81 (d, 1H); 7.47 (t, 1H); 2.94 (s, 3H).

### N-[(E)-1-(8-Bromo-2-quinolinyl)ethylidene]-2,6-bis(1-methylethyl)-benzenamine

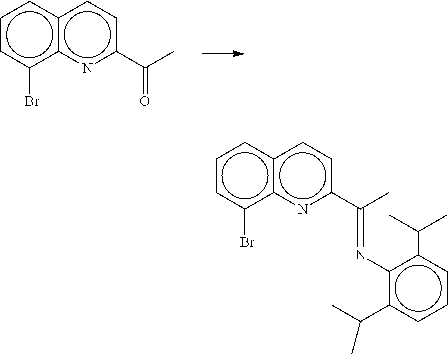

A mixture of 2-acetyl-8-bromoquinoline (2.5 g, 10 mmol), 2,6-diisopropylaniline (1.8 g, 10 mmol) and p-toluenesulfonic acid (0.1 g) is refluxed in ethanol (15 mL) for 3 h. The crystalline precipitate formed upon cooling is separated, washed with a small amount of ethanol, and dried (yield: 2.53 g, 62%). ¹H NMR (CDCl₃): 8.63 (d, 1H); 8.24 (d, 1H); 8.11 (d, 1H); 7.84 (d, 1H); 7.46 (t, 1H); 7.22 (m, 3H); 2.81 (m, 2H); 2.47 (s, 3H); 1.20 (dd, 12H).

### 2-[(1E)-1-[[2,6-Bis(1-methylethyl)phenyl]imino]ethyl]-N-(2,6-dimethylphenyl)-8-quinolinamine (1)

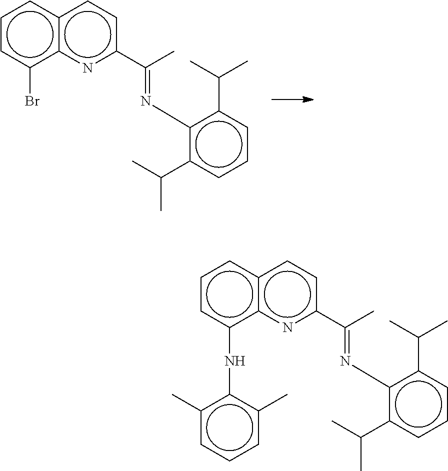

A mixture of (N-[(E)-1-(8-bromo-2-quinolinyl)ethylidene]-2,6-bis(1-methylethyl)benzenamine) (0.41 g, 1 mmol), 2,6-dimethylaniline (0.2 g, 1.6 mmol), toluene (5 mL), 20 mg of Pd(dba)₂, 40 mg of N-[2′-(dicyclohexylphoshino)(1,1′-biphenyl)-2-yl]-N,N-dimethylamine and sodium t-butoxide (0.15 g) is stirred for 6 h at 100-105° C. The resulting mixture is cooled to ambient temperature and treated with water. The organic layer is separated, while the aqueous phase is extracted with toluene (5 mL). The combined organic phases are dried (MgSO₄) and concentrated. The residue is purified on a silica column using hexane-benzene (1:1). Yield of precursor 1: 0.26 g (81%). ¹H NMR (CDCl₃): 8.57 (d, 1H); 8.22 (d, 1H); 7.71 (s, 1H); 7.35 (m, 2H); 7.20 (m, 6H); 6.35 (d, 1H); 2.84 (m, 2H); 2.39 (s, 3H); 2.33 (s, 6H); 1.21 (d, 12H).

### Preparation of Ligand Precursor 2

### 2-(1,3-Benzothiazol-2-yl)-8-bromoquinoline

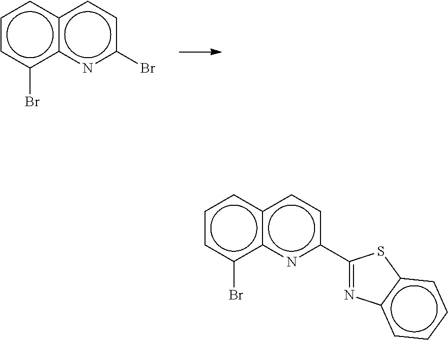

2,8-Dibromoquinoline (2.87 g, 10 mmol), 1,10-phenanthroline (0.18 g, 1 mmol), benzothiazole (1.35 g, 10 mmol) and N,N-dimethylformamide (6 mL) are combined under dry argon and stirred for 5 min. Copper(I) iodide (0.19 g, 1 mmol) and potassium phosphate (2.12 g, 10 mmol) are then added and the mixture is heated and stirred for 5 h at 120° C. The resulting mixture is diluted with water and extracted with methylene chloride. The organic extracts are dried over MgSO₄ and concentrated. The residue is recrystallized from ethanol-benzene. Yield: 0.8 g (25.5%). ¹H NMR (CDCl₃): 8.52 (d, 1H); 8.29 (d, 1H); 8.14 (d, 1H); 8.09 (d, 1H); 8.00 (d, 1H); 7.82 (d, 1H); 7.54 (t, 1H); 7.45 (m, 2H).

### N-[2-(1,3-Benzothiazol-2-yl)-8-quinolinyl]-N-(2,6-dimethylphenyl)amine (2)

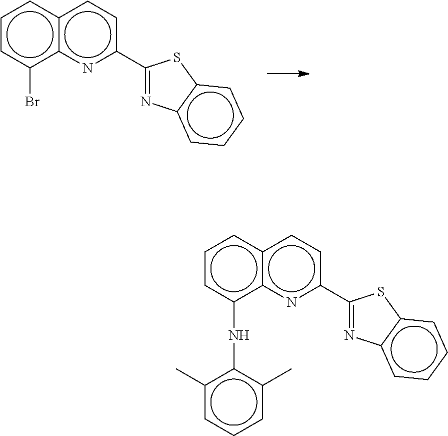

is A suspension of 2-(1,3-benzothiazol-2-yl)-8-bromoquinoline (0.8 g, 2.3 mmol), 2,6-dimethylaniline (0.4 mL, 3 mmol), sodium t-butoxide (0.5 g), Pd(dba)₂ (30 mg), N-[2′-(dicyclohexylphoshino)(1,1′-biphenyl)-2-yl]-N,N-dimethylamine (40 mg), and toluene (5 mL) is stirred for 4 h at 100-105° C. under argon. The resulting mixture is cooled to ambient temperature and is diluted with water. The organic phase is separated, and the aqueous layer is extracted with toluene (5 mL). The combined organic phases are dried over MgSO₄ and concentrated. The residue is eluted through a silica column using hexane-benzene (1:1). Yield: 0.5 g (57%). ¹H NMR (CDCl₃): 8.51 (d, 1H); 8.27 (d, 1H); 8.17 (d, 1H); 7.98 (d, 1H); 7.74 (s, 1H); 7.55 (t, 1H); 7.45 (t, 1H); 7.35 (t, 1H); 7.24 (m, 3H); 7.17 (d, 1H); 6.37 (d, 1H); 2.35 (s, 6H).

### Catalyst Preparation

### In-Situ Metallation

Catalysts are prepared by in-situ metallation. A 1:1 mole ratio of ligand precursor (0.06 mol) and transition metal source is used throughout. The transition metal sources are zirconium tetrabenzyl, hafnium tetrabenzyl, zirconium tetrachloride plus trimethylaluminum (Al/Zr=1.6 molar), hafnium tetrachloride plus trimethylaluminum (Al/Hf=1.6 molar), and vanadium oxytrichloride. The transition metal source and ligand precursor are slurried in toluene (0.5 mL) at ambient temperature for a specified length of time. The complexes are not isolated but are used directly to prepare a catalyst. Activator solution (2 mL of 2.41 M MAO with trityl tetrakis(pentafluorophenyl)borate in toluene; Al/metal ˜150 mole ratio; B/Metal ˜1.2 mole ratio) is added to the complex slurry, and the mixture is stirred for 30 min. The mixture is added to Davison 948 silica (2.2 g, calcined 6 h at 600° C.), and the resulting free flowing powder is to polymerize ethylene as described below.

### Ethylene Polymerization

A reactor is charged with isobutane (1 L), 1-butene (100 mL), triisobutylaluminum (1 mL of 1M solution; scavenger) and a specified amount of H₂ at 70° C. under 15 bar of partial ethylene pressure. A portion of catalyst (0.01 to 0.02 mmol of transition metal) is added to start the reaction. Polymerization continues at this temperature for ˜1 h, supplying ethylene on demand to maintain the 15 bar partial pressure. The polymerization is terminated by venting the reactor, resulting in white, uniform polymer powder.

The synthetic examples illustrate the use of coupling chemistry to quickly generate a variety of quinoline-based ligand precursors such as 1 and 2. The ability to use in-situ metallation allows preparation of a supported catalyst without the need to isolate and purify a transition metal complex. As the polymerization results shown in Table 1 indicate, catalysts of the invention offer polyolefin manufacturers good activity and the ability to make high-molecular-weight ethylene copolymers that have (based on rheology results) little or no long-chain branching.

### Preparation of Ligand Precursor 4

### 8-Bromoquinoline-2-carbaldehyde

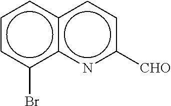

8-Bromoquinaldine (11 g, 50 mmol) is dissolved in a minimum amount of dioxane, and this solution is added at 80° C. to a mixture of dioxane (60 mL), water (2.5 mL), and selenium dioxide (7.0 g, 63 mmol). The reaction mixture stirs for 1 h at 80° C. and is then cooled to ambient temperature and filtered through a thin layer of silica. The solvent is removed under vacuum and the resulting product is used without further treatment.

### N-[(E)-(8-Bromoquinolin-2-yl)methylidene]-2,6-diisopropylaniline

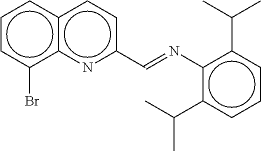

2,6-Diisopropylaniline (2.0 g, 11 mmol) and p-toluenesulfonic acid (50 mg) are added to a solution of 8-bromoquinoline-2-carbaldehyde (2.36 g, 10 mmol) in ethanol. The mixture is heated and refluxed for 2 min. and cooled to ambient temperature. The precipitate is separated, washed with ethanol (5 mL), and dried under vacuum. Yield: 3.32 g (84%).

### 2-{(E)-[(2,6-Diisopropylphenyl)imino]methyl}-N-(2,6-dimethylphenyl)-8-quinolinamine

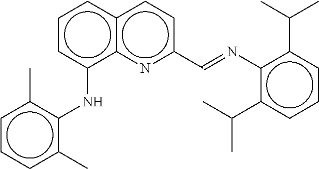

A mixture of N-[(E)-(8-bromoquinolin-2-yl)methylidene]-2,6-diisopropyl-aniline (1.0 g, 2.5 mmol), 2,6-dimethylaniline (0.40 g, 3.3 mmol), sodium tert-butoxide (0.5 g), toluene (5 mL), Pd(dba)₂ (30 mg) and (N-[2′-(dicyclohexylphosphino)[1,1′-biphenyl]-2-yl]-N,N-dimethylamine) (40 mg) is stirred at 105° C. for 4 h under argon. The product is purified using column chromatography (SiO₂, hexane-benzene 2:1). Yield: 0.70 g (64%).

### 2-[(2,6-Diisopropylanilino)(phenyl)methyl]-N-(2,6-dimethylphenyl)-8-quinolinamine (Precursor 4)

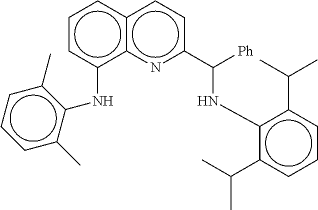

Phenyllithium (6.2 mL of 1.2 M solution in Et₂O, 7.5 mmol) is added to a solution of 2-{(E)-[(2,6-diisopropylphenyl)imino]methyl}-N-(2,6-dimethylphenyl)-8-quinolinamine (1.0 g, 2.5 mmol) in THF (10 mL). The mixture is stirred for 16 h and quenched with water (10 mL). The organic phase is combined with ether extracts (3×10 mL) of the aqueous phase. The combined organic phase is dried (MgSO₄) and concentrated, and the residue is purified by column chromatography (SiO₂, hexane-benzene 1:1). Yield: 0.82 g (64%).

### Metallation of Ligand Precursor 4 with Zr(Bn)₄ and Ethylene Polymerization

A catalyst is prepared from ligand precursor 4 using zirconium tetrabenzyl and the in-situ metallation procedure described above, with a two-hour metallation time. The resulting supported catalyst mixture is then used to polymerize ethylene without added hydrogen, also by the method described earlier. Activity: 5,100 kg PE/mol Zr/h. M_{w}: not soluble. Branches per 1000 carbons: 8.0. Tₘ by DSC: 124.8° C. η (100 rad/s): 39,500 P.

TABLE 1
Ethylene Polymerization using Catalysts made by In-Situ Metallation

| | Ligand | Metal | Rxn. | H₂ | Activity, | | | Branches/ | Tₘ, | η (P) at | |
|---|---|---|---|---|---|---|---|---|---|---|---|
| Ex. | precursor | source | time¹, h | charge² | kg/mol/h | M_{w} | M_{w}/Mₙ | 1000 C | DSC | 100 rad/s | Er |
| 1 | 1 | ZrBz₄ | 15 | 0 | 3,010 | not sol | n/a | 6.6 | 123.0 | 98,000 | n/a |
| 2 | 1 | ZrBz₄ | 15 | 100 | 4,241 | not sol | n/a | 6.0 | 125.4 | 49,700 | 1.18 |
| 3 | 1 | ZrBz₄ | 150 | 100 | 5,384 | 791K | 14.6 | 6.1 | 125.9 | 47,600 | 2.45 |
| 4 | 1 | ZrBz₄ | 150 | 300 | 3,534 | 462K | 26.8 | 9.9 | 125.3 | 18,600 | 3.41 |
| 5 | 1 | HfBz₄ | 15 | 0 | 4,366 | not sol | n/a | 7.2 | 119.5 | 100,000 | n/a |
| 6 | 1 | HfBz₄ | 15 | 300 | 2,211 | 157K | 4.5 | 13.0 | 119.7; | 14,500 | 2 |
| | | | | | | | | | 108 | | |
| 7 | 1 | AlMe₃/ | 15 | 0 | 8,153 | not sol | n/a | 2.7 | 128.2 | 54,500 | 1.71 |
| | | ZrCl₄ | | | | | | | | | |
| 8 | 1 | AlMe₃/ | 15 | 300 | 4,387 | 104K | 14.7 | 5.3 | 128.1 | 5,780 | 3.42 |
| | | ZrCl₄ | | | | | | | | | |
| 9 | 1 | AlMe₃/ | 2 | 0 | 3,850 | not sol | n/a | 5.5 | 120; | 33,300 | 3.69 |
| | | HfCl₄ | | | | | | | 57.5 | | |
| 10 | 1 | VOCl₃ | 2 | 0 | 3,655 | not sol | n/a | 8.7 | 119.8 | 30,300 | 3.69 |
| 11 | 2 | ZrBz₄ | 15 | 300 | 374 | 660K | 15.2 | 9.7 | 125.6 | — | — |
| 12 | 2 | ZrBz₄ | 15 | 0 | 457 | not sol | n/a | 7.1 | 125.6 | — | — |
| C13 | 3³ | AlMe₃/ | 15 | 0 | 2,374 | not sol | n/a | 3.6 | 127.2 | — | — |
| | | ZrCl₄ | | | | | | | | | |

¹Reaction time for metallation.
²Δpsi from 300 mL H₂ storage vessel.
³Ligand precursor 3 is [(2,4,6-Me₃C₆H₂)NHCH₂CH₂]₂NH (see U.S. Pat. No. 6,271,323, Ex. 1 for its preparation method)

### Preparation of Zirconium Complex 5

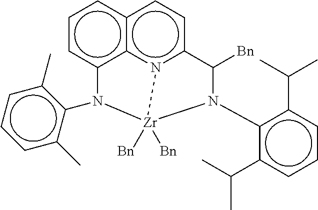

A cold (−20° C.) solution of 2-{(E)-[(2,6-diisopropylphenyl)imino]-methyl}-N-(2,6-dimethylphenyl)-8-quinolinamine (0.24 g, 0.54 mmol) in toluene (5 mL) is added to a cold (−20° C.) solution of tetrabenzylzirconium (0.32 g, 0.7 mmol) in a 1:1 mixture of toluene-hexane (15 mL). The resulting reddish-brown mixture warms to ambient temperature and is stirred for 16 h. The solution is decanted, concentrated to ˜1 mL, followed by addition of hexane (5 mL). The resulting dark-brown, crystalline residue is washed with hexane and dried under vacuum. Yield: 0.27 g (64%).

¹H NMR (C₆D₆) δ: 7.34-6.65 (large m.); 6.23 (d, 1H); 6.16 (d, 1H); 6.05 (d, 2H); 5.12 (broad d, 1H); 3.99 (m, 1H); 3.24 (broad m, 2H); 2.59 (s, 3H); 2.47 (d, 1H); 2.21 (m, 2H); 2.11 (s, 3H); 1.95 (d, 1H); 1.68 (broad m, 1H); 1.51 (d, 3H); 1.27 (d, 3H); 1.21 (d, 6H).

The structure indicated above is further confirmed by x-ray analysis.

### Preparation of Hafnium Complex 6

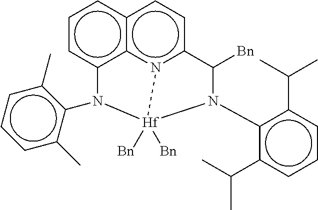

Hafnium complex 6 is prepared using the procedure above for making the zirconium analog, starting with 2-{(E)-[(2,6-diisopropylphenyl)imino]methyl}-N-(2,6-dimethylphenyl)-8-quinolinamine (0.20 g, 0.47 mmol) and tetrabenzylhafnium (0.33 g, 0.61 mmol). Yield of red-brown crystals: 0.28 g (68%).

¹H NMR (C₆D₆) δ: 7.35-6.63 (large m.); 6.24 (d, 1H); 6.08 (d, 3H); 5.18 (m, 1H); 4.13 (m, 1H); 3.23 (dd, 1H); 3.13 (m, 1H); 2.68 (s, 3H); 2.54 (d, 1H); 2.40 (d, 1H); 2.12 (s, 3H); 1.95 (d, 1H); 1.81 (d, 1H); 1.50 (m, 1H); 1.42 (d, 3H); 1.32 (d, 3H); 1.19 (d, 3H); 1.17 (d, 3H).

### Ethylene Polymerization Using Complexes 5 and 6

Zirconium complex 5 and hafnium complex 6 are used to polymerize ethylene without added hydrogen as described above. For Zr complex 5: Activity: 7,699 kg PE/mol Zr/h. M_{w}: 121 K. M_{w}/Mₙ: 156. Branches per 1000 carbons: 8.4; Tₘ: 122.5, 116.5. n (100 rad/s): 431 P. Er: 9.1. For Hf complex 6: Activity: 1,430 kg PE/mol Hf/h. M_{w}: 24 K. M_{w}/Mₙ: 46.

As demonstrated in the examples immediately above, complexes made from the quinoline-based NNN precursors (e.g., complexes 5 and 6) can be isolated and characterized if desired prior to their use as olefin polymerization catalysts.

The preceding examples are meant only as illustrations. The following claims define the invention.

We claim:

1. A catalyst useful for polymerizing olefins, comprising a transition metal complex, an optional activator, and an optional support, wherein the complex comprises the reaction product of a Group 3-6 transition metal source, an optional alkylating agent, and a ligand precursor comprising a 2-imino-8-anilinoquinoline or a 2-aminoalkyl-8-anilinoquinoline.

2. The catalyst of claim 1 wherein the alkylating agent is an alkylaluminum compound.

3. The catalyst of claim 1 wherein the transition metal source comprises a Group 4 or 5 metal.

4. The catalyst of claim 1 wherein the transition metal source has the formula MX₄ wherein M a Group 4 metal and each X is independently alkyl, aryl, aralkyl, alkaryl, alkoxy, halide, heterocyclyl, or dialkylamido.

5. The catalyst of claim 1 wherein the ligand precursor and the alkylating agent are pre-reacted prior to reacting with the transition metal source.

6. The catalyst of claim 1 wherein the activator is a mixture of an alumoxane and a boron compound having Lewis acidity.

7. The catalyst of claim 1 wherein the ligand precursor has the structure: 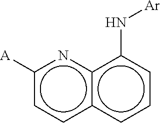
in which Ar is an aryl group, A is a 2-imino or 2-aminoalkyl substituent, and any of the ring carbons is optionally substituted with an alkyl, aryl, aralkyl, alkaryl, halide, haloalkyl, heterocyclyl, trialkylsilyl, alkoxy, amino, thio, or phosphino group, or any pair of adjacent ring carbons join to form a 5 to 7-membered carbocyclic or heterocyclic ring.

8. The catalyst of claim 7 wherein A is a monovalent substituent having the structure: 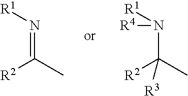
in which each of R¹-R⁴ is independently hydrogen, alkyl, aryl, aralkyl, alkaryl, halide, heterocyclyl, trialkylsilyl, alkoxy, amino, thio, or phosphino, or any of R¹-R⁴ join to form a 5 to 7-membered carbocyclic or heterocyclic ring.

9. The catalyst of claim 8 wherein the precursor has the structure: 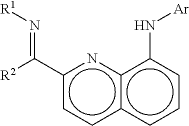
and the complex has the structure: 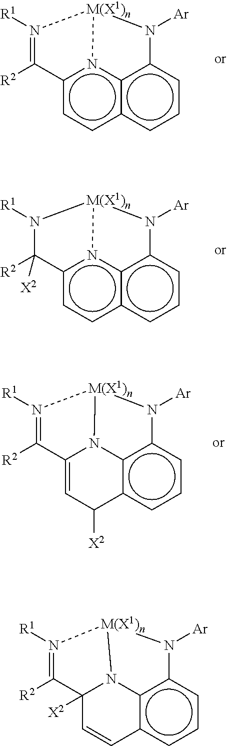
wherein M is a Group 3-6 metal, each X¹ is independently alkyl, aryl, aralkyl, alkaryl, halide, heterocyclyl, or dialkylamido, X² is hydrogen, alkyl, aryl, aralkyl, or alkaryl, and n is an integer from 1 to 5 that satisfies the valence of M.

10. The catalyst of claim 9 wherein M is a Group 4 metal.

11. The catalyst of claim 8 wherein the ligand precursor has the structure: 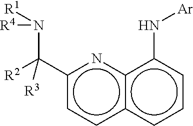
and the complex has the structure: 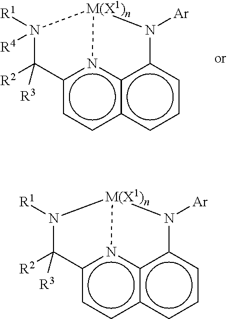
wherein M is a Group 3-6 metal, each X¹ is independently alkyl, aryl, aralkyl, alkaryl, halide, heterocyclyl, or dialkylamido, and n is an integer from 1 to 5 that satisfies the valence of M.

12. The catalyst of claim 11 wherein M is a Group 4 metal.

13. A silica-supported catalyst of claim 1.

14. The catalyst of claim 1 further comprising a Group 8-10 transition metal complex.

15. A process which comprises polymerizing at least one of ethylene, propylene, and a C₄-C₂₀ α-olefin in the presence of the catalyst of claim 1.

16. The process of claim 15 wherein the α-olefin is selected from the group consisting of 1-butene, 1-hexene, 1-octene, and mixtures thereof.
